(19) United States
(12) Patent Application Publication
(10) Pub. No.: US 2012/0110348 A1
(43) Pub. Date: May 3, 2012

(54) Secure Page Tables in Multiprocessor Environments

(75) Inventors: H. Peter Hofstee, Austin, TX (US); Brian Flachs, Georgetown, TX (US); Charles R. Johns, Austin, TX (US)

(73) Assignee: International Business Machines Corporation, Armonk, NY (US)

(21) Appl. No.: 12/917,092

(22) Filed: Nov. 1, 2010

(51) Int. Cl. G06F 12/10; G06F 12/14

(52) U.S. Cl. 713/190; 711/206; 711/E12.059; 711/E12.092

(57) ABSTRACT

A system comprises a memory module configured to store signed page table data and a selected processing element coupled to the memory module. The selected processing element is one of a plurality of processing elements, which together comprise a portion of a multiprocessor system. The selected processing element is configured to authenticate page table management code and, based on authenticated page table management code, to sign page table data that is subsequently stored in the memory module, and to verify signed page table data that is read from the memory module.

### TECHNICAL FIELD

The present invention relates generally to the field of parallel processing and, more particularly, to secure page tables in multiprocessor environments.

### BACKGROUND

Modern electronic computing systems, such as microprocessor systems, often employ memory virtualization techniques to enhance system performance. Generally, memory virtualization offers applications more memory addresses than are physically present in the system. Many common systems implement memory virtualization through a paging mechanism.

More specifically, in many typical systems, processes refer to storage using “virtual addresses” that refer to a virtual address space, which is typically larger that the physically available random access storage, such as dynamic random access memory (DRAM), for example. Typical systems access the physically available random access storage using what is commonly referred to as “real addresses.” In order to limit the complexity of managing memory and of translating virtual addresses to real addresses, typical systems map virtual addresses to physical addresses on a per-block basis, where such blocks are referred to as pages. Typical systems use a “page table” to keep track of the status of the pages and their location in random access memory or on a disk. Typical systems also track access privileges for a particular page as a part of the status the page table. Typical systems rely on the information stored in the page table to grant or deny an application (process) access to a page of memory. Therefore, the page table is a key component to maintaining the integrity and security of a system.

In typical systems, system software is responsible for memory management and for maintaining the page table. In many cases, the system software is either an operating system, or, in systems that support multiple operating systems running concurrently, a hypervisor. In typical systems, system software creates page table entries when application processes or new operating system partitions are created, or when such applications or partitions request more memory. Similarly, in typical systems, these page table entries are deleted when memory is released or when applications or partitions end. In typical systems, if an application requests data stored in an address that is not currently present in main memory, the system loads the page containing the requested address from disk into memory. Sometimes, this requires the system to move another page from main memory to backup disk storage, to make room for the incoming page.

In a typical system, however, the page table itself is at least partially stored in main memory. In such systems, storing the page table in main memory exposes the system to hardware attacks because the bus connecting the processor to memory is generally readily accessible. Even systems with signed or encrypted page tables can, in some cases, be compromised, for example by preventing page table updates or by replacing a section of the page table with a previously signed copy. Recent attacks on such systems demonstrate that even systems with encrypted page tables that are also protected by a hypervisor are vulnerable.

In a typical system, system software is responsible for maintaining the page table and for managing application memory access privileges. This system software is complex, however, and frequently has vulnerabilities that can allow lower-level software to gain control. Once lower-level software gains control, it is in full control of the page table and the security of the system is compromised. A vulnerability in a section of system code that is not related to maintaining the page table or to maintaining system security can therefore compromise the security of the entire system.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

A system comprises a memory module configured to store signed page table data and a selected processing element coupled to the memory module. The selected processing element is one of a plurality of processing elements, which together comprise a portion of a multiprocessor system. The selected processing element is configured to authenticate page table management code and, based on authenticated page table management code, to sign page table data that is subsequently stored in the memory module, and to verify signed page table data that is read from the memory module.

A method for managing memory in a multiprocessor system includes receiving, by a selected secure processing element, a command identifying a memory management transaction. The selected processing element is one of a plurality of processing elements, the plurality of processing elements together comprising a portion of a multiprocessor system. The selected processing element comprises an internal state and is configured in a secure state, the secure state blocking access to the internal state by any other processing element. The selected processing element authenticates page table management code, the page table management code being configured to execute based on the memory management transaction. If the page table management code is authentic, the selected processing element loads a portion of a secured page table into a local store of the selected processing element. The selected processing element verifies the portion of the secured page table to determine whether the portion of the secured page table is authentic. The selected processing element is configured to sign and to verify the secured page table. In the event the portion of the secured page table is authentic, the selected processing element processes the memory management request, modifying the portion of the page table as needed and re-signing it before storing the modified page table in memory.

A method for managing memory in a multiprocessor system includes receiving a memory management request. The method determines whether at least one available processing element of a plurality of processing elements is configured for secure memory management transaction processing. In the event at least one processing element is configured for secure memory management transaction processing, a selected processing element is selected from among the at least one processing elements configured for secure memory management transaction processing. In the event there is not at least one available processing element configured for secure memory management transaction processing, a selected processing element is selected from among the available processing elements. The selected processing element is configured for secure memory management transaction processing. The memory management request is passed to the selected processing element.

### BRIEF DESCRIPTION OF THE SEVERAL VIEWS OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing a memory management system in accordance with one embodiment;

FIG. 2 illustrates a high-level flow diagram depicting logical operational steps of a memory management method, which can be implemented in accordance with one embodiment; and

FIG. 3 illustrates a high-level flow diagram depicting logical operational steps of another memory management method, which can be implemented in accordance with one embodiment; and

FIGS. 4A and 4B illustrate high-level flow diagrams depicting logical operational steps of another memory management method, which can be implemented in accordance with one embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, user interface or input/output techniques, and the like, have been omitted inasmuch as such details are not considered necessary to obtain a complete understanding of the present invention, and are considered to be within the understanding of persons of ordinary skill in the relevant art.

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

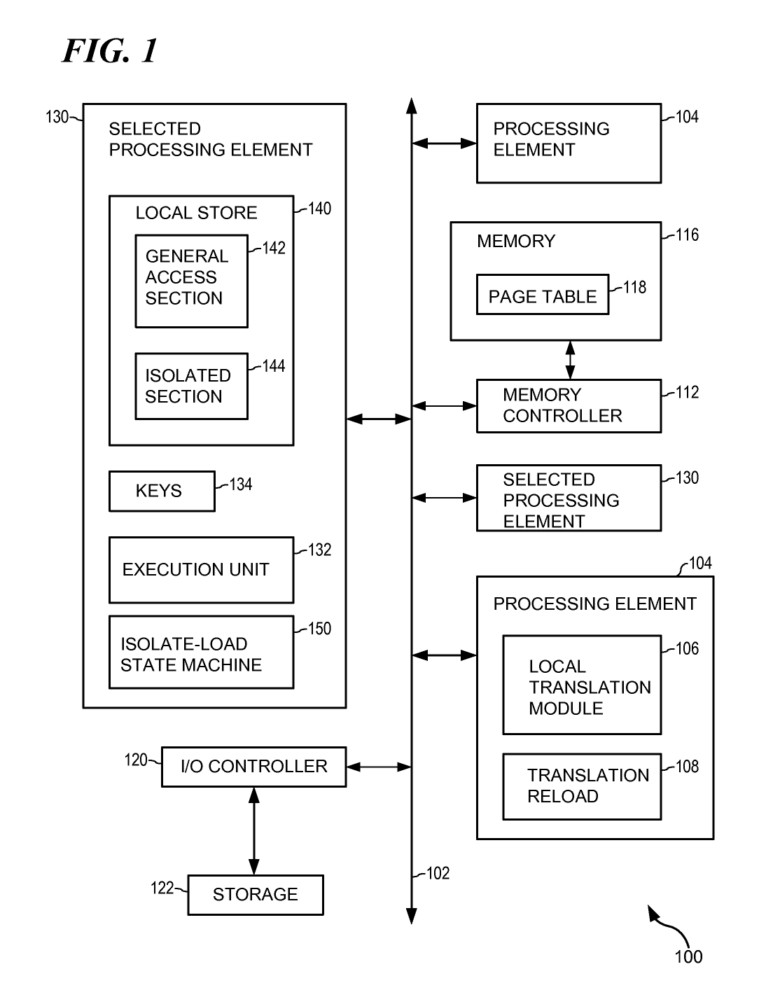

Referring now to the drawings, FIG. 1 is a high-level block diagram illustrating certain components of a system 100 for improved memory management, in accordance with a preferred embodiment of the present invention. Generally, as described above, a typical prior art system modifies its page table though execution of a large piece of software, such as the operating system (OS) or a Hypervisor, for example. So configured, the typical prior art page table is vulnerable to attack in at least two ways. First, as described above, the typical page table is stored in main memory, which is typically connected to the processor through a bus that is exposed and subject to attack. Second, because typical systems do not provide varying security levels within the OS or Hypervisor, once a software (or hardware) attack gains access to any portion of the OS or Hypervisor, the typical prior art page table can be modified by the attacker. It would therefore be desirable to have a mechanism where the page table is protected against attack and where any access to the page table or modification to the page table is performed only by trusted hardware or by code that has been authorized to perform these functions and where this authorization is authenticated by the hardware.

In the embodiments described herein, these security threats are significantly reduced. For example, as described in more detail below, certain embodiments described herein isolate the code that is allowed to make modifications to the page table. Additionally, certain embodiments execute the code that is allowed to modify the page table in a hardware protected environment, such as an SPE in the Cell processor running in a secure state, for example. In one such embodiment, a processor validates the authenticity of the code that is authorized to modify the page table before it is executed, and the code itself is hardware-protected from software attacks. Additionally, some embodiments store the page table in main memory in such a way (e.g., signed and, in some embodiments, encrypted) that the system can detect unauthorized page table modification.

For example, in one embodiment, instead of being serviced directly by the OS or hypervisor, the system passes a request to modify the page table to the designated secure processor. As described in more detail below, the designated secure processor is, in one embodiment, an SPE, operating in isolate mode, that is loaded with the code that is allowed to make modifications to the page table.

As described in more detail below, this configuration offers numerous technical advantages over prior systems. For example, a computing system so configured can ensure that modifications to the page table are made only by code that has been authenticated to do so, and that such code and the page table itself are hardware-protected from attack. One skilled in the art will appreciate that the computational overhead supporting this approach is small relative to the resultant increase in security.

Additionally, other aspects of the disclosed embodiments also improve performance relative to prior art systems and methods. For example, in one embodiment, as described in more detail below, when the system accesses the page table to service a page table cache miss (e.g., a translation lookaside buffer (TLB) miss), the system hardware validates the integrity of the page table before its data is used to replace the missing cache (TLB) entry. In one embodiment, as an alternative to a hardware TLB reload, the designated secure processor hardware reloads the TLB. As described in more detail below, in one embodiment, the designated secure processor is an SPE, operating in isolate mode, which the system has provided with a secure communication path with the TLB. As described in more detail below, in one embodiment, the system instruction set includes a secure TLB reload instruction that can only be executed by a secure processor that has been authenticated explicitly to perform such an instruction.

For clarity, the detailed description below describes various illustrative embodiments in an architecture with a single level of address translation. One skilled in the art will understand that, generally, programs in such architectures operate on virtual addresses that are translated to physical (or “real”) addresses as described above. One skilled in the art will also understand that some processor architectures employ two-level address translation, for example, by segmenting an effective address space into multiple virtual address spaces. Generally, address translation in such architectures depends on entries in both a segment table and a page table. Thus, it will be clear to those skilled in the art how to apply the embodiments described herein in multi-level address translation architectures. For example, in one embodiment, all of the translation tables and local copies or caches of such table entries can be securely managed by the embodiments described herein. One skilled in the art will understand that the disclosed embodiments can also securely manage new tables constructed from combining entries from such translation tables, such as an effective to real address translation table in a segmented virtual architecture, for example.

These principles are further described with respect to the particular embodiments as described below. For example, system 100 includes a system bus 102. System bus 102 is an otherwise conventional system bus.

One or more processing elements 104 couple to system bus 102. For clarity, FIG. 1 shows two processing elements 104. One skilled in the art will understand that multiprocessor environments frequently couple multiple processing elements and/or cores to a system bus. In the illustrated embodiment, processing element 104 includes a local translation module 106.

Generally, local translation module 106 is configured to translate between virtualized addresses and/or indicating whether a particular memory address resides in the page table (and therefore main memory). For example, in one embodiment, local translation module 106 includes a local address map, as described in more detail below. In one embodiment, local translation module 106 is a translation lookaside buffer (TLB). In one embodiment, a TLB translates a virtual address (VA) into a real address (RA). In one embodiment, processing element 104 reads translation module 106 to translate the VA into an RA, which application code uses to access physical memory. In one embodiment, application or system management code on processing element 104 does not directly access the translation module 106. In one embodiment, as described in more detail below, updates (writes) to the translation module 106 are performed by either selected processing element 130, or by a hardware translation table update mechanism in processing element 104, enhanced to authenticate page table entries before updating local translation module 106.

In the illustrated embodiment, bus 102 is configured such that only an authenticated processing element 130 can issue bus transactions that result in updates to translation module 106. In one embodiment, selected processing element 130 must perform an “unlock sequence” before the system hardware allows any translation module update instructions to issued, as described in more detail below. For example in one embodiment, an unlock sequence includes writing specific key values to a selected register.

In the illustrated embodiment, processing element 104 also includes a translation reload module 108. In one embodiment, translation reload module 108 is a hardware translation table reload mechanism coupled to local translation module 106. Generally, translation reload module 108 is configured to select a victim entry in local translation module 106 to be replaced, and to load a new entry from the page table 118. In one embodiment, translation reload module 108 is further configured to load a signed block of page table entries from page table 118, and to ensure the loaded page table block authenticates prior to performing the update to local translation module 106.

In the illustrated embodiment, system 100 includes a main memory 116. In one embodiment, memory 116 is an otherwise conventional memory, modified as described herein. For example, in one embodiment, memory 116 is a dynamic random access memory (DRAM). In one embodiment, memory 116 is a synchronous DRAM (SDRAM). In one embodiment, memory 116 is a static random access memory (SRAM).

Memory 116 includes page table 118. Generally, page table 118 is an otherwise conventional page table, modified as described herein. In one embodiment, page table 118 is an address map. In one embodiment, page table 118 is a secure page table. Generally, as used herein, a “secured page table” is a page table that has been signed and/or hashed, and/or encrypted with one or more keys.

As described in more detail below, in one embodiment, only a selected processing element 130 is authorized and/or enabled to sign page table 118. In one embodiment, system 100 is configured with a plurality of selected processing elements 130, and any of the plurality of selected processing elements 130 is enabled to sign table 118. In one embodiment, system 100 is a Cell Broadband Engine and any of the SPE can be configured as a secure processor that is able to modify and re-sign page table 118 or a portion of page table 118.

In one embodiment, page table 118 includes an address map with signed address data. In one embodiment, page table 118 includes an address map with hashed address data. In one embodiment, page table 118 includes an address map with encrypted data.

System 100 also includes an input/output (I/O) controller 120. I/O controller 120 couples to system bus 102 and is an otherwise conventional I/O controller. In one embodiment, I/O controller 120 is configured to move pages from storage 122 to devices coupled to system bus 102. Storage 122 couples to I/O controller 120 and is an otherwise conventional storage unit or unit(s). For example, in one embodiment, storage 122 is a disk drive. One skilled in the art will understand that there are a wide variety of suitable storage units in which storage 122 can be embodied.

System 100 also includes a selected processing element (SPE) 130. SPE 130 couples to system bus 102. Generally, in one embodiment, SPE 130 is a processing element configured to perform various address mapping and virtualization functions, as described in more detail below. For example, in one embodiment, SPE 130 is configured to perform page table lookups and page table maintenance, as described in more detail below. For clarity, in the illustrated embodiment, FIG. 1 shows system 100 with two SPEs 130. One skilled in the art will understand that system 100 can include a plurality of SPEs 130. As described in more detail below, system 100 can configure a processing element 104 as an SPE 130.

SPE 130 includes an execution unit 132. In one embodiment, execution unit 132 is an otherwise conventional processing element execution unit, modified as described herein. Generally, execution unit 132 executes instructions and processes and issues memory commands, as described in more detail below.

SPE 130 also includes a key or keys 134. Generally, keys 134 are one or more encryption keys. In one embodiment, key 134 is a hardware key. In one embodiment, keys 134 are a hardware key and a plurality of keys derived from the hardware key. One skilled in the art will understand that other suitable configurations can also be employed. Generally, SPE 130 uses keys 134 to decrypt, verify, sign, and/or encrypt data in the course of operation, as described in more detail below.

SPE 130 also includes a local store 140. Generally, local store 140 is an otherwise conventional processing element storage, modified as described herein. In the illustrated embodiment, local store 140 includes a general access section 142 and an isolated section 144. In one embodiment, general access section 142 is a section of local store 140 configured to be addressable by one or more processing elements 104.

Generally, isolated section 144 is a section of local store 140 configured such that only SPE 130 is enabled to read to or write from isolated section 144. In the illustrated embodiment, isolated section 144 is configured as a static section of local store 140. In an alternate embodiment, isolated section 144 is a section of local store 140 that is dynamically allocated and de-allocated by SPE 130 during operation. In one embodiment, SPE 130 is configured to operate in an “isolated” mode, wherein SPE 130 conducts all local storage operations using isolated section 144.

In the illustrated embodiment, SPE 130 also includes an otherwise conventional Isolate-Load State Machine (ILSM) 150. In one embodiment, ILSM 150 is configured to manage various security and cryptographic functions relating to operation of SPE 130 is isolated mode. In one embodiment, ILSM 150 is configured to initiate and terminate isolated mode for SPE 130. In one embodiment, ILSM 150 is also configured to authenticate memory management code, as described in more detail below.

In one embodiment, SPE 130 is configured with an instruction set that includes hardware instructions to perform updates of hardware translation structures. For example, in one embodiment, SPE 130 is configured with a “TLBIE” (TLB—invalidate entry) instruction. As described in more detail below, in one embodiment, SPE 130 is configured to issue page table and other memory commands.

Generally, in operation in one embodiment, system 100 processes data and memory commands, moving data back and forth between memory 116 and storage 122. Each processing element 104 and SPE 130 operates on data according to various program instructions. Generally, these operations are consistent with typical operations of ordinary homogeneous and heterogeneous multiprocessor systems.

As described in more detail below, SPE 130, and certain other components of system 100, also performs certain functions in support of a secured memory management framework. Specifically, in one embodiment SPE 130 is configured to provide for secure page table and translation hardware management. In one embodiment, system 100 leverages and extends vault-based security techniques to perform page table lookups and page table maintenance.

For example, in one embodiment, as described in more detail below, SPE 130 stores parts of page table 118 in isolated section 144 (a “vault”). In one embodiment, system 100 stores the page table at large in memory 116, which, in one embodiment, is signed and encrypted. As described in more detail below, in one embodiment, SPE 130 is configured to access and modify page table 118 in isolated mode. In one embodiment, only an SPE 130 that has authenticated the relevant memory management code is authorized to modify page table 118.

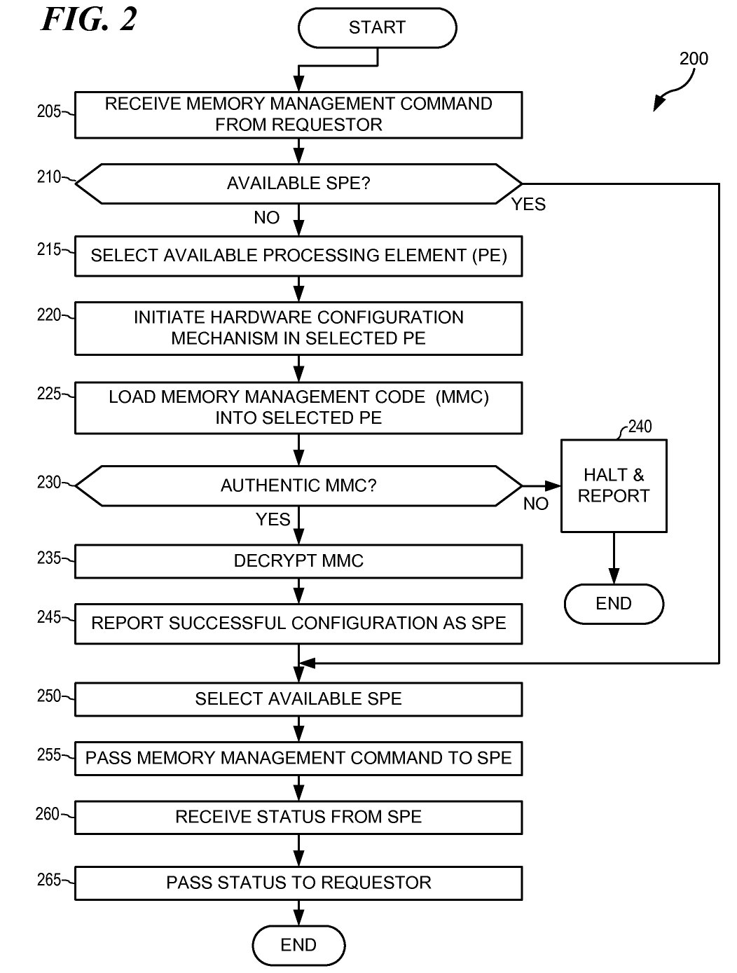

In one embodiment, system 100 stores page table 118 in blocks and SPE 130 modifies page table 118 at the block level. In one embodiment, system 100 includes a hierarchical signature and authentication scheme to ensure that a block (including the signature) cannot be replaced in memory by an earlier version. FIGS. 2-4 describe specific embodiments in additional detail.

FIG. 2 illustrates one embodiment of a method for memory management. Specifically, FIG. 2 illustrates a high-level flow chart 200 that depicts logical operational steps performed by, for example, system 100 of FIG. 1, which may be implemented in accordance with a preferred embodiment. Generally, a system OS and/or hypervisor performs the steps of the method, unless indicated otherwise. One skilled in the art will understand that the allocation of functions in a particular system can be configured as desired and as consistent with the disclosed embodiments.

As indicated at block 205, the process begins, wherein the operating system receives a memory management command from a requestor. Generally, as used herein, a “memory management command” is a command to perform one or more memory management functions, such as, for example, a request to service a translation miss, a request to allocate or de-allocate memory, a request to create a new partition, or commands to move pages between memory 116 and storage 122. More generally, as used herein, a “memory management command” includes all commands that require writing to or reading from page table 118, and/or local translation module(s) 106. Generally, in one embodiment, a “requestor” is either a processing element 104 or SPE 130. In an alternate embodiment, a “requestor” includes other system 100 components.

Next, as indicated at decisional block 210, the operating system determines whether there is an SPE 130 available to process the memory management command. If at decisional block 210 there is an SPE 130 available to process the memory management command, the process continues along the YES branch to block 250, described below. If at decisional block 210 there is not an SPE 130 available to process the memory management command, the process continues along the NO branch to block 215.

As indicated at block 215, the operating system selects a processing element (PE) from among the available PEs in system 100. In one embodiment, the operating system follows a pre-determined heuristic and/or algorithm to select an available PE. Next, as indicated at block 220, the operating system initiates a hardware configuration mechanism in the selected PE. In one embodiment, the hardware configuration mechanism is isolate load sequence that configures the selected PE in isolated mode and authenticates memory management code loaded into the selected PE. In one embodiment, the hardware configuration mechanism is as described with respect to blocks 225 through 240, below.

As indicated at block 225, the selected PE, now functioning as an SPE 130, loads memory management code (MMC) into its local store. As described above, in one embodiment, MMC is code configured to perform memory commands and page table management, among other things. Next, as indicated at block 230, SPE 130 determines whether the loaded MMC is authentic. One skilled in the art will understand that there are a variety of mechanisms suitable to make this determination, including, for example, verification against a hardware key 134.

If at decisional block 230 the loaded MMC is not authentic, the process continues along the NO branch to block 240. As indicated at block 240, in one embodiment, SPE 130 reports the authentication failure to the operating system and halts. In another embodiment, SPE 130 halts execution of the MMC and reports the authentication failure, and the failure to reconfigure as an SPE, to the operating system. If the loaded MMC is not authentic, the process ends.

If at decisional block 230, the loaded MMC is authentic, the process continues along the YES branch to block 240. Next, as indicated at block 245, SPE 130 reports to the operating system that SPE 130 is successfully configured as an SPE.

Next, as indicated at block 250, the operating system selects an SPE from among the available SPEs. Next, as indicated at block 255, the operating system passes the received memory management request to the selected SPE. Next, as indicated at block 260, the operating system receives a status of the memory management command from the selected SPE. In one embodiment, the status is a confirmation of the memory management command (either as a success or failure) and does not include page table information.

The process continues to block 265, wherein the operating system passes the received status to the requestor, and the process ends. Thus, in one embodiment, system 100 can be configured to reserve certain page table functions to SPE 130, as described in more detail below, while reserving certain routine memory commands to the components ordinarily permitted to issue such routine memory commands.

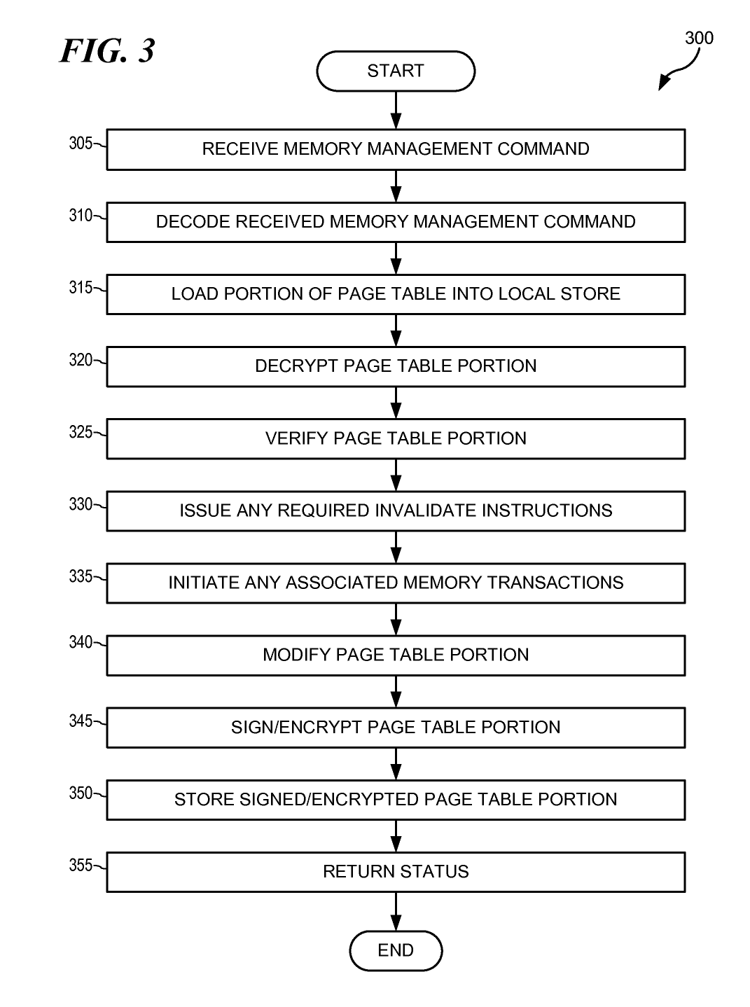

FIG. 3 illustrates one embodiment of a method for memory management. Specifically, FIG. 3 illustrates a high-level flow chart 300 that depicts logical operational steps performed by, for example, system 100 of FIG. 1, which may be implemented in accordance with a preferred embodiment. Generally, SPE 130 performs the steps of the method, unless indicated otherwise.

The process begins at block 305, wherein SPE 130 receives a memory management command. As described above, in one embodiment, the operating system forwards certain memory management commands to SPE 130. Next, as indicated at block 310, SPE 130 decodes the received memory management command. In one embodiment, decoding the received memory management command includes identifying a portion of the page table providing information about the contents of a memory address referenced in the memory management command. Next, as indicated at block 315, SPE 130 loads a portion of page table 118 into local store 140. Specifically, in one embodiment, SPE 130 loads a portion of page table 118 into isolated section 144. In an alternate embodiment, SPE 130 loads a portion of a local translation module 106 into isolated section 114.

Next, as indicated at block 320, SPE 130 decrypts the loaded page table portion. In one embodiment, SPE 130 uses a hardware key 134 to decrypt the loaded page table portion. As described above, in one embodiment, keys 134 are a hardware encryption key and (optionally) one or more additional keys derived from the hardware encryption key. One skilled in the art will understand that in embodiments wherein page table 118 is not encrypted, this block may be omitted.

Next, as indicated at block 325, SPE 130 verifies the decrypted (or unencrypted) page table portion. In one embodiment, SPE 130 uses a hardware key 134 to verify the loaded page table portion. As described above, in one embodiment, keys 134 are a hardware encryption key and (optionally) one or more additional keys derived from the hardware encryption key. In one embodiment, if SPE 130 determines that page table 118 is not verified, SPE 130 reports an error and/or the process ends. In one embodiment, if SPE 130 determines that page table 118 is not verified, SPE 130 reports an error and/or reloads the portion of page table 118. If SPE 130 determines that the portion of page table 118 is verified, the process continues to block 330.

Next, as indicated at block 330, SPE 130 issues any required invalidate instructions. For example, in one embodiment, SPE 130 issues instructions to invalidate one or more entries in the loaded portion of page table 118. One skilled in the art will understand that memory management commands sometimes require invalidation of one or more page table entries before the memory management command can execute without disrupting memory coherency.

Next, as indicated at block 335, SPE 130 initiates any associated memory transactions. For example, in one embodiment, SPE 130 initiates any associated memory transactions based on the received memory management command. One skilled in the art will understand that a memory management command can sometimes require multiple memory transactions to issue as a consequence of, or to prepare for, the memory management command.

Next, as indicated at block 340, SPE 130 modifies the page table portion, if necessary, based on the memory management command, any required invalidate instructions, and/or any associated memory transactions. One skilled in the art will understand that memory management commands sometimes do not require page table modifications.

Next, as indicated at block 345, SPE 130 signs and (optionally) encrypts the page table portion. In one embodiment, SPE 130 signs the page table portion. In one embodiment, SPE 130 signs and encrypts the page table portion. In one embodiment, SPE 130 uses hardware keys 134 to sign and/or encrypt the page table portion.

Next, as indicated at block 350, SPE 130 stores the signed/encrypted page table portion. In one embodiment, SPE 130 signs or stores the page table portion only if SPE 130 has modified that page table portion. In one embodiment, SPE 130 signs and stores the page table portion even if SPE 130 has not modified the page table portion as described in block 340.

Next, as indicated at block 355, SPE 130 returns a status of the memory management command execution, and the process ends. In one embodiment, SPE 130 notifies the requestor of the memory management command of the status of the command.

As described above, SPE 130 is described as receiving a memory management command while in the isolated state. In one embodiment, SPE 130 is configured to enter and exit the isolated state as necessary to service memory management commands. In an alternate embodiment, SPE 130 remains in the isolated state for a pre-determined period of time after servicing a memory management command.

One skilled in the art will understand that certain details regarding the processing of memory management commands have been omitted so as not to cloud the description of the disclosed embodiments. As such, the specific actions taken as described in, for example, blocks 330 through 340 can vary depending on the particular memory management command. For example, memory management commands include commands based on a page fault, a request to allocate memory, a request to create a new partition, a translation lookaside buffer (TLB) miss, and other suitable commands. One skilled in the art will understand that the invalidate instructions and memory transactions are typically not the same for a page fault and a request to allocate memory, for example.

As described above, in one embodiment, the operating system forwards certain memory management commands to SPE 130. In an alternate embodiment, certain memory management transactions are configured to interface with SPE 130 without intermediation by the operating system. For example, in one embodiment, memory management commands for handling a TLB miss are configured to call SPE 130 directly, without operating system approval or interference.

For example, in one embodiment, where some memory management commands can call SPE 130 directly, SPE 130 determines whether it is in isolate mode and whether it is pre-loaded with memory management code. If SPE 130 is not in isolate mode, SPE 130 enters isolate mode. If SPE 130 is not pre-loaded with memory management code, SPE 130 loads and validates memory management code. So configured, SPE 130 begins the process as indicated at block 310, decoding a received memory management command. Similarly, after returning the status (as indicated at block 355), SPE 130 can remain in isolate mode or return to normal operation. In one embodiment, the operating system and/or hypervisor can be configured to allocate and de-allocate SPEs for memory management. As such, the disclosed embodiments can be configured to avoid violating the general principle that machine resources are managed by the OS or Hypervisor.

Thus, in one embodiment, system 100 can be configured to perform secure page table lookup (and other address mapping) operations in a vault-type processing environment. Additionally, system 100 can be configured to perform secure page table (and other address map) maintenance operations in a vault-type processing environment.

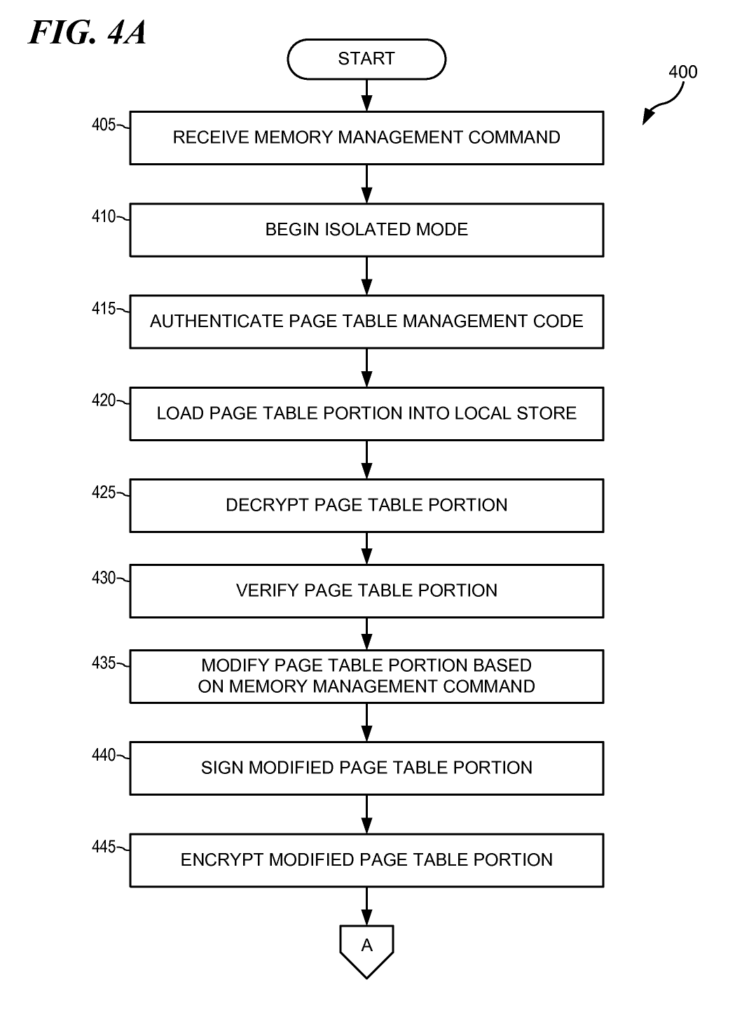

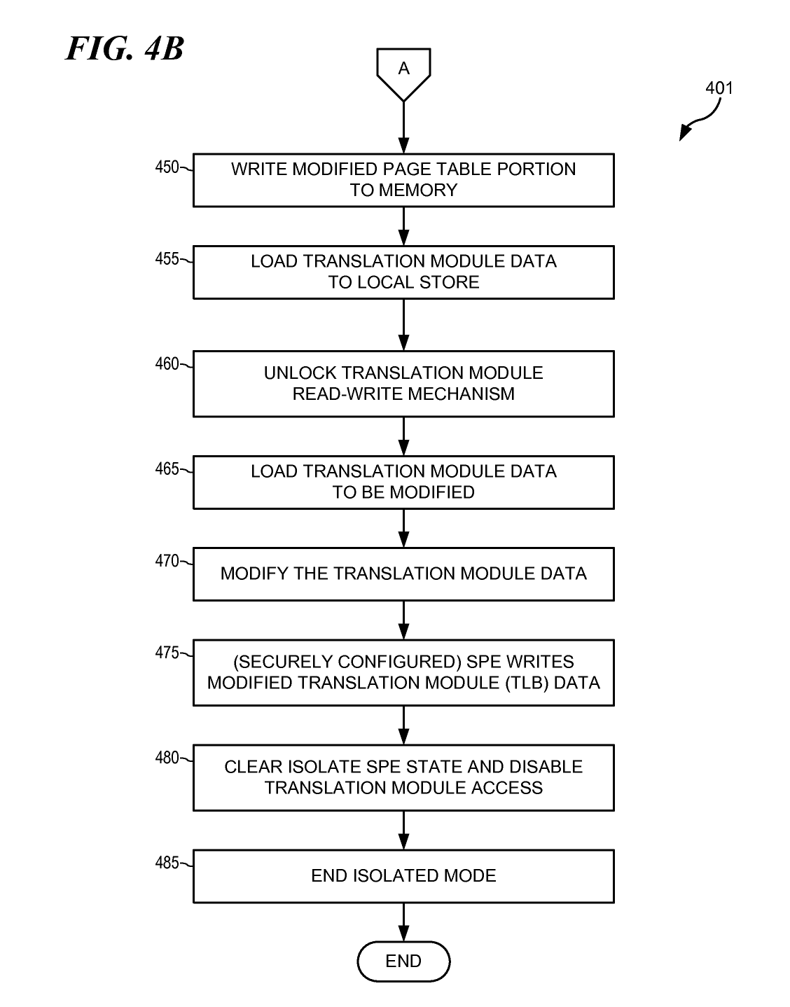

FIG. 4A illustrates one embodiment of a method for memory management. Specifically, FIG. 4A illustrates a high-level flow chart 400 that depicts logical operational steps performed by, for example, system 100 of FIG. 1, which may be implemented in accordance with a preferred embodiment. Generally, SPE 130 performs the steps of the method, unless indicated otherwise.

The process begins at block 405, wherein SPE 130 receives a memory command and/or pagination notice. As used herein, a pagination notice is a memory command requiring page table management. As described above, in one embodiment, memory controller 112 forwards certain memory commands to SPE 130.

Next, as indicated at block 410, SPE 130 begins isolated mode operation. In one embodiment, during isolated mode operation, SPE 130 restricts all local execution to isolated section 144. Next, as indicated at block 415, SPE 130 authenticates page table management code. In one embodiment, page table management code is a list of instructions configured to process memory commands.

In one embodiment, page table management code includes memory management code. In one embodiment, SPE 130 authenticates page table management code using a unique hardware key.

Next, as indicated at block 420, SPE 130 loads a portion of page table 118 into local store 140. Specifically, in one embodiment, SPE 130 loads a portion of page table 118 into isolated section 144. In an alternate embodiment, SPE 130 loads a portion of a local translation module 106 into isolated section 144.

Next, as indicated at block 425, SPE 130 decrypts the loaded portion of page table 118. In one embodiment, SPE 130 decrypts the loaded portion of page table 118 using keys 134. As described above, in one embodiment, keys 134 are a hardware encryption key and (optionally) one or more additional keys derived from the hardware encryption key. One skilled in the art will understand that in embodiments wherein page table 118 is not encrypted, this block may be omitted.

Next, as indicated at block 430, SPE 130 verifies the loaded portion of page table 118. In one embodiment, SPE 130 verifies whether the loaded portion of page table 118 has been modified using keys 134. In one embodiment, SPE 130 verifies the portion of page table 118 as encrypted. In one embodiment, SPE 130 verifies the portion of page table 118 as decrypted. In one embodiment, if SPE 130 determines that page table 118 is not verified, SPE 130 reports an error and/or the process ends. In one embodiment, if SPE 130 determines that page table 118 is not verified, SPE 130 reports an error and/or reloads the portion of page table 118. If SPE 130 determines that the portion of page table 118 is verified, the process continues to block 435.

Next, as indicated at block 435, SPE 130 modifies the portion of page table 118 based on the memory management command. As described above, in one embodiment SPE 130 selects the victim page(s) and generates memory commands implementing page exchanges. Next, as indicated at block 440, SPE 130 signs the modified page table portion. In one embodiment, SPE 130 signs the modified page table portion using keys 134.

Next, as indicated at block 445, SPE 130 encrypts the modified (verified) page table portion. In one embodiment, SPE 130 encrypts the modified page table portion using keys 134. The process continues to marker “A” of FIG. 4B.

FIG. 4B illustrates one embodiment of a method for memory management. Specifically, FIG. 4B illustrates a high-level flow chart 401 that depicts logical operational steps performed by, for example, system 100 of FIG. 1, which may be implemented in accordance with a preferred embodiment. Generally, SPE 130 performs the steps of the method, unless indicated otherwise.

The process continues from marker “A” to block 450. As indicated at block 445, SPE 130 stores the modified portion of the page table in memory. Next, as indicated at block 455, SPE 130 loads one or more translation module 106 entries into local store 140. In one embodiment, SPE 130 loads those translation module entries that are out of date in light of the page table modifications as described in block 435.

Next, as indicated at block 460, SPE 130 unlocks the translation module access mechanism. In one implementation translation module access is unlocked by writing a specific secret key to a specified register.

Next, as indicated at block 465, SPE 130 loads the portion of the translation module to be modified. In one implementation this portion corresponds to entries in the translation lookaside buffer.

Next, as indicated at block 470, SPE 130 modifies the loaded translation module entries based on the memory management command. In one embodiment, SPE 130 modifies the loaded translation module entries based on the modifications as described in block 430.

Next, as indicated at block 475, SPE 130 writes new entries to the translation module 106. In one embodiment, SPE 130 sends commands implementing the modifications to the translation modules to the appropriate processing elements 104.

Next, as indicated at block 480, SPE 130 clears local store 140 and disables translation module access. In one embodiment, SPE 140 clears only isolated section 144. Next, as indicated at block 485, SPE 130 ends isolated mode operation and the process ends. Thus, in one embodiment, system 100 can be configured to perform secure page table (and other address map) maintenance operations in a vault-type processing environment.

Thus, generally, system 100 can be configured to leverage a secure vault-based computing element, such as a Cell Broadband Engine processor Synergistic Processor Element in isolate mode) to perform secure page table lookups and page table maintenance. The Selected Processing Element (SPE) can be configured with extended instructions to perform hardware translation structure updates and the hardware can be configured to ensure that only the authorized processing element (the SPE) in isolated mode can perform the translation tale updates.

Accordingly, the disclosed embodiments provide numerous advantages over other methods and systems. For example, the disclosed embodiments extend vault-based security to provide hardware-based security to the translation structures. This minimizes software dependency and reduces hardware-based attack opportunities. Thus, the disclosed embodiments also provide a more secure multiprocessor computing environment than typical systems and methods.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A system, comprising:
a memory module configured to store signed page table data; and
a selected processing element coupled to the memory module;
wherein the selected processing element is one of a plurality of processing elements, the plurality of processing elements together comprising a portion of a multiprocessor system; and
wherein the selected processing element is configured to authenticate page table management code and, based on authenticated page table management code, to sign page table data that is subsequently stored in the memory module and to verify signed page table data that is read from the memory module.

2. The system of claim 1, wherein the selected processing element comprises:
a processor,
a local store, the local store comprising an isolated section, and
a key.

3. The system of claim 1, wherein the selected processing element is configured to operate in an isolated mode.

4. The system of claim 1, further comprising a translation module coupled to the memory module, the translation module configured to store page table data.

5. The system of claim 1, wherein each of the plurality of processing elements comprises a local translation module.

6. A method for managing memory in a multiprocessor system, comprising:
receiving, by a selected secure processing element, a command identifying a memory management transaction;
wherein the selected processing element is one of a plurality of processing elements, the plurality of processing elements together comprising a portion of a multiprocessor system;
wherein the selected processing element comprises an internal state and is configured in a secure state, the secure state blocking access to the internal state by any other processing element;
authenticating, by the selected processing element, page table management code, the page table management code configured to execute based on the memory management transaction;
in the event the page table management code is authentic, loading a portion of a secured page table into the local store of the selected processing element;
verifying, by the selected processing element, the portion of the secured page table to determine whether the portion of the secured page table is authentic;
in the event the portion of the secured page table is authentic:
processing the memory management request,
modifying the portion of the secured page table, if necessary, based on the memory management request, and
re-signing the modified secured page table, and
storing the signed modified secured page table in memory.

7. The method of claim 6, further comprising decrypting the secured page table.

8. The method of claim 6, further comprising:
entering, by the selected processing element, an isolated mode; and
wherein the selected processing element verifies the portion of the secured page table in the isolated mode

9. The method of claim 6, further comprising wiping the local store.

10. The method of claim 6, wherein processing the memory management request includes issuing a command to modify a translation module.

11. The method of claim 6, wherein processing the memory management request includes issuing a page table command.

12. The method of claim 6, further comprising generating a page table entry.

13. The method of claim 6, further comprising:
generating a page table entry; and
signing the page table entry.

14. The method of claim 6, further comprising:
generating a page table entry;
signing the page table entry; and
encrypting the page table entry.

15. A method for managing memory in a multiprocessor system, comprising:
receiving a memory management request;
determining whether at least one available processing element of a plurality of processing elements is configured for secure memory management transaction processing;
in the event at least one processing element is configured for secure memory management transaction processing,
selecting a selected processing element from among the at least one processing elements configured for secure memory management transaction processing; and
passing the memory management request to the selected processing element; and
in the event there is not at least one available processing element configured for secure memory management transaction processing,
selecting a selected processing element from among the available processing elements;
configuring the selected processing element for secure memory management transaction processing; and
passing the memory management request to the selected processing element.

16. The method of claim 15, wherein configuring the selected processing element to securely process memory management transactions comprises providing a hardware-protected execution environment.

17. The method of claim 15, wherein configuring a selected processing element for secure memory management transaction processing comprises executing a hardware mechanism configured to:
load at least a portion of memory management code into the selected processing element,
wherein the memory management code is authorized to perform memory management transactions;
authenticate the loaded portion of memory management code; and
decrypt the loaded portion of memory management code with a hardware key.

18. The method of claim 17, wherein configuring the secure processing element further includes interrupting execution if the loaded code does not authenticate.

19. The method of claim 15, wherein configuring a selected processing element for secure memory management transaction processing includes
loading at least a portion of memory management code into the selected processing element; and
providing at last one encryption key,
wherein the at least one encryption key is required to sign a page table of the multiprocessor system and to perform updates of locally cached copies of the page table in local translation tables.
